(19) United States
(12) Patent Application Publication
(10) Pub. No.: US 2013/0243570 A1
(43) Pub. Date: Sep. 19, 2013

(54) Hydraulic Turbomachine

(71) Applicant: Martin Schabasser, Obritzberg (AT)

(72) Inventor: Martin Schabasser, Obritzberg (AT)

(73) Assignee: VOITH PATENT GmbH, Heidenheim (DE)

(21) Appl. No.: 13/879,897

(22) PCT Filed: Jan. 31, 2012
(86) PCT No.: PCT/EP2012/000404

§ 371 Date: Jun. 10, 2013

(30) Foreign Application Priority Data
Feb. 16, 2011 (DE) 10 2011 011 444.0

(51) Int. Cl. F03B 7/00

(52) U.S. Cl. CPC F03B 7/00
USPC 415/3.1

(57) ABSTRACT

The invention relates to a hydraulic turbomachine comprising a runner acted upon by water, said runner having a plurality of guide vanes, a spiral housing enclosing the runner, a traverse ring having two traverse ring decks that are interconnected by cross-beams, and lengths of pipe enveloping the traverse ring, said lengths of pipe being interconnected one after the other in the circumferential direction and the flow-sections thereof tapering in the flow direction of the water. The invention is characterized by the following features: at least one reinforcing element is mounted on the outer circumference of the spiral housing in the region of the connecting point between two lengths of pipe, which reinforcing element locally interconnects two lengths of pipe at a time; a plurality of reinforcing elements which are distributed on the circumference of the spiral housing above the connecting point between two lengths of pipe; and the reinforcing element is mounted on the spiral housing in the region of the transition from the spiral housing to the respective traverse ring deck.

The invention concerns a hydraulic turbomachine, in particular a water turbine, a pump turbine or a pump, according to the preamble of claim 1. These may be Francis or Kaplan-type machines or other machines. The main thing is that these machines should have a spiral housing.

It may be referred to documents U.S. Pat. No. 4,496,282 or DE 199 50 228 A1.

The spiral housing of such a turbomachine encloses the runner. It is situated in a plane vertical to the rotary axis of the runner. Since the runner axis extends generally vertically this is here a horizontal plane.

The spiral housing is open to the runner on its inner side. It has hence an annular gap which extends around the inner periphery of the spiral housing so that working medium can flow out of the spiral housing through the annular gap on the whole inner periphery to the runner. The annular gap is hence defined by two circumferential edges.

A traverse ring connects to the annular gap as seen in the flow direction. It contains two traverse ring decks which are arranged concentrically to the rotational axis of the runner and have a mutual distance in the axial direction. The traverse ring decks are interconnected by the so-called cross-beams which absorb the tensile forces. Moreover, each of said circumferential edges of the spiral housing is fixedly connected to one of both traverse ring decks.

The spiral housing is hence composed of tight rows of lengths of pipe in the circumferential direction enveloping the traverse ring decks. The various lengths of pipe have hence previously been welded on the one hand with the traverse ring decks and on the other hand to each other. The abutting edges of two consecutive lengths of pipe are then welded together by forming a bevel.

Since the lengths of pipe are strongly stressed by water pressure during the operation of the turbomachine said connecting point should be designed in such a way that said point is subjected to a uniform stress. Known attachments for reducing said stress consisted so far in using larger transition radii between both abutting edges of the lengths of pipe. Such transition radii however go together with an increased wall thickness of the spiral housing and hence with higher costs of material. Consequently, the whole spiral housing fitted with the traverse ring represents a costly and expensive element of such a hydraulic turbomachine. In addition, the assembly of such an element is time-consuming.

The object of the invention is then to design a hydraulic turbomachine of the type above mentioned in such a way that the stresses of the spiral housing can be reduced significantly, the amount of material can be decreased and the production as well as assembly costs can be lowered significantly.

This object is satisfied by the characteristics of the independent claims. The dependent claims describe advantageous and particularly appropriate embodiments of the invention.

A hydraulic turbomachine according to the invention with a runner which is acted upon by water, a runner containing a plurality of guide vanes, comprises a spiral housing, which surrounds the runner, as well as a traverse ring, comprising two traverse ring decks, which are interconnected by cross-beams. Moreover the traverse ring contains enveloping lengths of pipe which are interconnected consecutively in the circumferential direction and whose flow cross-section tapers in the flow direction of the water.

According to the invention, at least one reinforcing element is mounted on the outer circumference of the spiral housing in the region of the connecting point between two lengths of pipe, which locally interconnects two lengths of pipe at a time.

The inventor is fully aware that the stress will be distributed optimally at the transition of both lengths of pipe thanks to this extremely efficient measure which consists in adding a reinforcing element above the connecting point of two lengths of pipe. Smaller wall thicknesses of the spiral housing can now be used thanks to this optimal stress distribution which enables to decrease the costs of material as well as to reduce the costs of production of such a hydraulic turbomachine.

The reinforcing element is advantageously designed as a reinforcing rip with a U-shaped cross-section, comprising two legs, whereas each leg is arranged on a respective length of pipe. Since in such a case the reinforcing element is in the form of a lug it can be used simultaneously as a stopping means for securing lifting devices, through which the assembly of such a spiral housing is simplified significantly.

The invention will now be described more in detail in the light of the figures.

The figures are as follows:

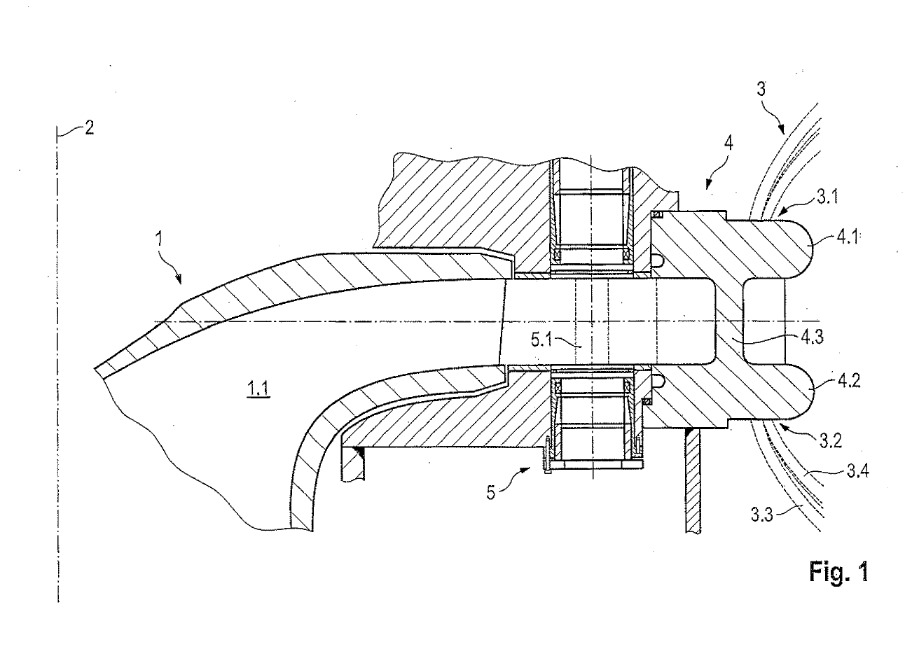

FIG. 1 shows a cross-section through the rotational axis of a hydraulic turbomachine configured as a Francis turbine;

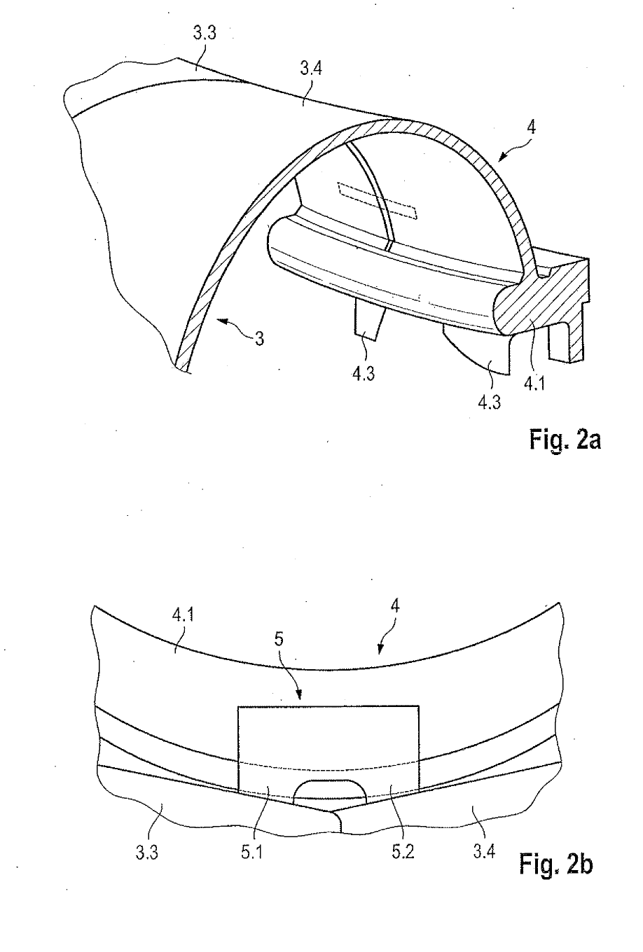

FIG. 2a shows a three-dimensional representation of a circular cutout of a traverse ring and spiral housing;

FIG. 2b is an elevation view on the object of FIG. 2.

The Francis turbine represented in FIG. 1 has a runner 1. Said runner contains a plurality of guide vanes 1.1. The runner 1 rotates around a rotational axis 2.

The runner 1 is enclosed by a spiral housing 3. The spiral housing 3 has for example a circular cross-section. It has a circumferential annular gap, which is open to the runner 1. The annular gap is delineated by circumferential edges 3.1, 3.2.

A traverse ring 4 connects to the annular gap. It contains two traverse ring decks 4.1 and 4.2. At least one traverse 4.3 is provided for supporting the traverse ring decks 4.1 and 4.2.

The areas of the circumferential edges 3.1, 3.2 of the annular gap 3 are welded to the traverse ring decks 4.1, 4.2. Two lengths of pipe 3.3, 3.4 can also be seen. These envelope the traverse ring 4 and are welded together consecutively in the circumferential direction of the spiral housing 3. The lengths of pipe 3.3, 3.4 form the spiral housing 3.

A guiding apparatus 5 with guide vane 5.1 is provided between traverse ring 4 and runner 1.

A suction pipe, not shown, is connected to the runner 1 as seen in the flow direction.

FIG. 2a shows a circular cutout of the spiral housing 3 as well as the traverse ring 4 connected thereto in a three-dimensional representation. Substantially, the same elements are provided with the same reference signs as in FIG. 1.

As can be seen from FIG. 2a, a reinforcing element is provided (see the dotted line) on the unswept outer circumference of the spiral housing 3 in the region of the transition between spiral housing 3 and traverse ring 4. Said reinforcing element is welded on the outer circumference and hence connects both consecutive lengths of pipe 3.4 and 3.4 to each other. Naturally, other connections, in particular frictional or positive connections could also be envisioned. The reinforcing element enables to improve the stress distribution in the connection point of both abutting edges of the lengths of pipe 3.3, 3.4. It lies in a vertical plane on the spiral housing 3. This could also quite different. The reinforcing element enables to reduce the so-called bevel tension which appears in the abutting edges of the lengths of pipe 3.3, 3.4 which are here assembled using a bevel joint. Smaller wall thicknesses of the spiral housing can hence be used, so that the costs of material are lower.

FIG. 2b shows the object of FIG. 2a in an elevation view on the reinforcing element. There again, the same elements are provided with the same reference signs as in FIG. 2a.

It can be seen that the reinforcing element is designed as a reinforcing rip 5 with a U-shaped cross-section, comprising two legs 5.1 and 5.2, from which each here is connected by welding to a corresponding length of pipe 3.3 or 3.4. Naturally, a cross-sectional shape of the reinforcing rip differing from the U-shaped could also be envisioned. In the present case, said shape can also serve as stopping means due to the eyelet-like shape so that the welded lengths of pipe 3.3, 3.4 can be transported simply by means of a lifting device.

Moreover, a plurality of such reinforcing rips can be provided over the periphery of the spiral housing 3.

### LIST OF REFERENCE NUMERALS

1 Runner
1.1 Guide vane
2 Rotational axis
3 Spiral housing
3.1, 3.2 Circumferential edge
3.3, 3.4 Lengths of pipe
4 Traverse ring
4.1, 4.2 Traverse ring deck
4.3 Traverse
5 Reinforcing rip
5.1, 5.2 Leg

1-2. (canceled)

3. A hydraulic turbomachine comprising:
a runner acted upon by water, which includes a plurality of guide vanes;
a spiral housing enclosing the runner;
a traverse ring, comprising two traverse ring decks, which are interconnected by cross-beams;
with lengths of pipe enveloping the traverse ring, which are interconnected consecutively in the circumferential direction and whose flow cross-section tapers in the flow direction of the water;
wherein:
at least one reinforcing element is mounted on the outer circumference of the spiral housing in the region of the connecting point between two lengths of pipe, which locally interconnects two lengths of pipe at a time;
a plurality of reinforcing elements distributed on the circumference of the spiral housing is provided above the connecting point between two lengths of pipe;
the reinforcing element is arranged on the spiral housing in the region of the transition from the spiral housing to the respective traverse ring deck.

4. A hydraulic turbomachine according to claim 3, wherein the reinforcing element is designed as a reinforcing rip with a U-shaped cross-section, comprising two legs, and wherein a respective leg is arranged on a respective length of pipe.
